(19) United States
(12) Patent Application Publication
(10) Pub. No.: US 2023/0260323 A1
(43) Pub. Date: Aug. 17, 2023

(54) SYSTEM AND METHOD FOR RECOGNIZING AN ENTITY

(71) Applicant: Jio Platforms Limited, Ahmedabad (IN)

(72) Inventors: Jitendra BHATIA, Navi Mumbai (IN); Amit Kumar JAIN, Sagar (IN); Indraksha AGARWAL, Saharanpur (IN); Tribhuvan Singh RATHORE, Ajmer (IN)

(73) Assignee: Jio Platforms Limited, Ahmedabad (IN)

(21) Appl. No.: 18/170,626

(22) Filed: Feb. 17, 2023

(30) Foreign Application Priority Data
Feb. 17, 2022 (IN) 202221008448

(51) Int. Cl. G06V 40/16; G06V 40/40; G06V 40/60

(52) U.S. Cl. CPC G06V 40/172; G06V 40/171; G06V 40/40; G06V 40/60; G06V 2201/10

(57) ABSTRACT

The present invention provides a system and a method for biometric authentication using facial information to recognize users across different locations. Further, the system generates feature vectors based on the facial information and generates recognition metadata for the identification and categorization of users. The system utilizes a frame relay (FR) connect pipeline to provide a more economically efficient solution, enable locations with improper bandwidth, and support a large number of locations on the same hardware. The system uses an artificial intelligence (AI) engine for predicting one or more categorizations of the user based on the generated one or more recognition metadata.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for biometric authentication and visitor analytics for providing user identification. More particularly, the present disclosure relates to a system and a method for providing value added recognition to entities that use a highly scalable frame relay (FR) solution that is economically efficient and provides bandwidth support for various locations.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Area access control utilizes face recognition, attendance capturing, or general security surveillance through smart camera deployment in various scenarios. Existing systems do not provide value creation for retail stores and stakeholders like customers, staff, and management. Even though systems exist for people registration, people recognition exist, the systems are highly expensive and complicated. Real time recognition via video streams consumes a lot of resources even in an idle situation. Further, bandwidth is intensive in nature and not a suitable for places having low number of registered users.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method that uses a camera with in-built face detection which helps in reduction of continuous bandwidth towards a frame relay (FR) cloud.

It is an object of the present disclosure to provide a system and a method that uses an artificial intelligence (AI) based sensor light that helps in energy saving and makes the system functioning independent of external lightening.

It is an object of the present disclosure to provide a system and a method that utilizes biometric authentication using facial information to recognize personnel across different locations.

It is an object of the present disclosure to provide a system and a method that utilizes an FR-connect pipeline to provide an economically efficient solution, enable locations which were not having proper bandwidth, and support a large number of locations on the same hardware.

It is an object of the present disclosure to provide a system and a method that enables multiple functionalities catering to attendance capture, blacklist person alert, and visitor analytics.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for generating user analytics. The system may include one or more processors operatively coupled with a memory that stores instructions to be executed by the one or more processors. The one or more processors may receive one or more images from a user. The one or more images may include one or more user faces and the user may be connected to the analytics platform via a network. The one or more processors may extract one or more features associated with the one or more user faces to generate a feature vector based on the extracted one or more features. The one or more processors may generate one or more recognition metadata based on the generated feature vector to identify the user. The one or more processors may predict, via an artificial intelligence (AI) engine, one or more categorizations of the user based on the generated one or more recognition metadata.

In an embodiment, the generated one or more recognition metadata may include at least one of a user age, a user gender, a user count, and a frequency of visit associated with the user.

In an embodiment, the one or more processors may be configured to perform spoof detection on the generated feature vector.

In an embodiment, the one or more processors may compare the generated one or more recognition metadata with one or more data stored in a database and enable the one or more categorizations of the user based on the comparison.

In an embodiment, the one or more processors may generate a blacklist for the user based on the identification of the user.

In an embodiment, the one or more processors may generate an array of N dimensions based on the extracted one or more features and enable the generation of the blacklist based on the array.

In an embodiment, the one or more categorizations of the user may include one of a registered user, a repeat user, and a first time user.

In an embodiment, the one or more features may include at least one of a bounding box, a landmark, and an aligned face crop associated with the one or more user faces.

In an embodiment, the one or more processors may selectively process the received one or more images from the user to extract the one or more features.

In another aspect, the present disclosure relates to a method for generating user analytics. The method may include receiving, by the one or more processors, one or more images from a user. The one or more images may include one or more user faces. The method may include extracting, by the one or more processors, one or more features associated with the one or more user faces for the generation of a feature vector based on the extracted one or more features. The method may include generating, by the one or more processors, one or more recognition metadata based on the generated feature vector to identify the user. The method may include predicting, by the one or more processors, via an AI engine, one or more categorizations of the user based on the generation of the one or more recognition metadata.

In an embodiment, the one or more recognition metadata may include at least one of a user age, a user gender, a user count, and a frequency of visit associated with the user.

In an embodiment, the method may include comparing, by the one or more processors, the generated one or more recognition metadata with one or more data stored in a database and enabling, by the one or more processors, the one or more categorizations of the user based on the comparison.

In an embodiment, the method may include generating, by the one or more processors, a blacklist for the user based on the identification of the user.

In an embodiment, the method may include generating, by the one or more processors, an array of N dimensions based on the extracting of the one or more features and generating, by the one or more processors, the blacklist based on the array.

In an embodiment, the one or more categorizations of the user may include one of a registered user, a repeat user, and a first time user.

In another aspect, the present disclosure relates to a user equipment (UE) for generating user analytics. The UE may include one or more processors communicatively coupled to one or more processors in a system. The one or more processors may be coupled with a memory that stores instructions to be executed by the one or more processors. The one or more processors may transmit one or more images to the one or more processors in the system via a network. The one or more processors in the system may receive the one or more images from the UE. The one or more images may include one or more user faces. The one or more processors in the system may extract one or more features associated with the one or more user faces to generate a feature vector based on the extracted one or more features. The one or more processors in the system may generate one or more recognition metadata based on the generated feature vector to identify the user. The one or more processors in the system may predict, via an AI engine, one or more categorizations of the user based on the generated one or more recognition metadata.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (110), in accordance with an embodiment of the present disclosure.

FIG. 2 illustrates an exemplary block diagram (200) of a proposed system (110), in accordance with an embodiment of the present disclosure.

FIGS. 3A-3D illustrate exemplary block diagrams that represent a recognition pipeline of the system (110), in accordance with embodiments of the present disclosure.

FIG. 4 illustrates an exemplary representation (400) associated with image capture and its implementation, in accordance with an embodiment of the present disclosure.

FIG. 5 illustrates an exemplary representation (500) associated with scaling of the proposed system (110) and its implementation, in accordance with an embodiment of the present disclosure.

FIG. 6 illustrates an exemplary computer system (600) in which or with which embodiments of the present disclosure may be utilized.

The foregoing shall be more apparent from the following more detailed description of the disclosure.

### BRIEF DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

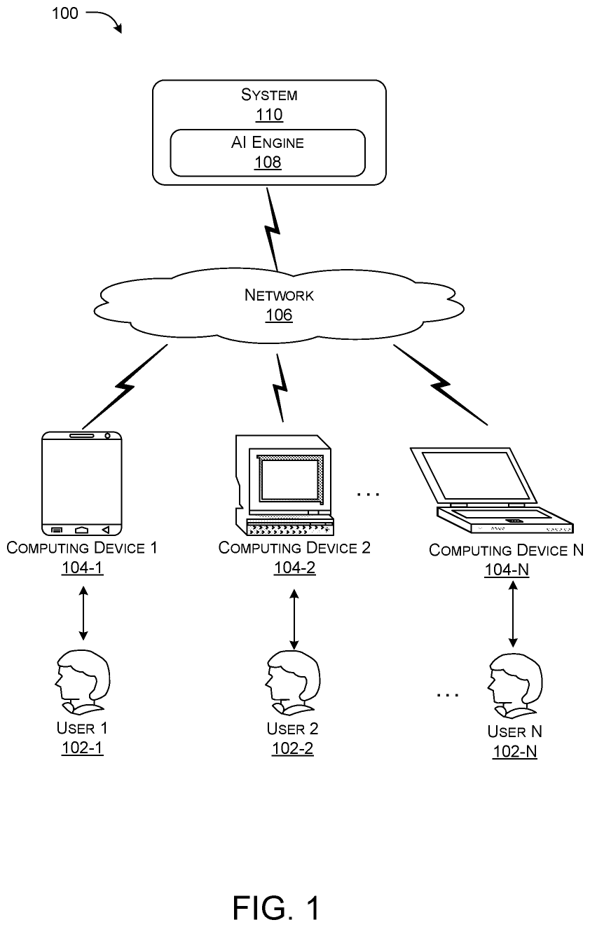

The various embodiments throughout the disclosure will be explained in more detail with reference to FIGS. 1-6.

FIG. 1 illustrates an exemplary network architecture (100) of a proposed system (110), in accordance with an embodiment of the present disclosure.

As illustrated in FIG. 1, the network architecture (100) may include a system. The system (110) may be implemented as an analytics platform for generating one or more user analytics. The system or analytics platform (110) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102). The system (110) may include an artificial intelligence (AI) engine (108) for predicting one or more categorizations of the user (102).

The computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from a user (102) such as a touch pad, touch-enabled screen, electronic pen, and the like may be used. A person of ordinary skill in the art will appreciate that the computing devices (104) may not be restricted to the mentioned devices and various other devices may be used.

The network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (110) may receive one or more images from the user (102). The one or more images may include one or more user faces.

In an embodiment, the system (110) may extract one or more features associated with the user face to generate a feature vector based on the extracted feature.

In an embodiment, the system (110) may generate one or more recognition metadata based on the generated feature vector to identify the user (102).

In an embodiment, the system (110) may perform spoof detection on the generated feature vector.

In an embodiment, the system (110) may predict via the AI engine (108) one or more categorizations of the user (102) based on the generated one or more recognition metadata.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

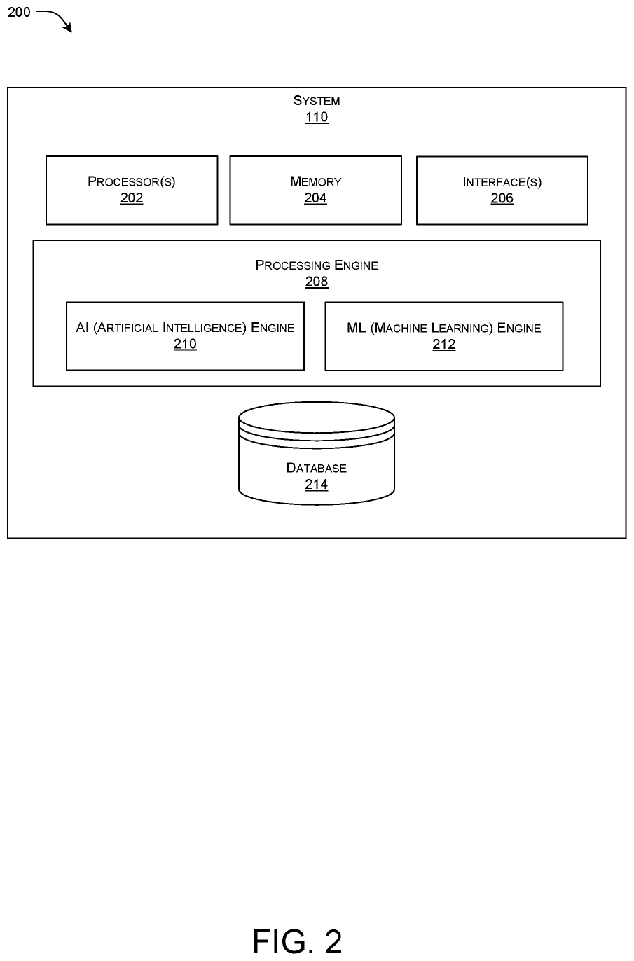

FIG. 2 illustrates an exemplary block diagram (200) of a proposed system (110), in accordance with an embodiment of the present disclosure.

Referring to FIG. 2, the system (110) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (110). Examples of such components include, but are not limited to, processing engine(s) (208), and, an AI engine (210), a machine learning (ML) engine (212), and a database (214). An ordinary person skilled in the art may understand that the AI engine (210) of FIG. 2 may be similar to the AI engine (108) of FIG. 1 in its functionality.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

In an embodiment, the one or more processors (202) may receive one or more images from a user (102). The one or more images may comprise one or more user faces. Further, the one or more processors (202) may extract one or more features associated with the one or more user faces to generate a feature vector based on the extracted feature. The one or more features may include, but not be limited to, a bounding box, a landmark, and an aligned face crop associated with the user face.

In an embodiment, the one or more processors (202) may generate one or more recognition metadata based on the generated feature vector to identify the user (102). The generated one or more recognition metadata of the user (102) may include, but not be limited to, a user age, a user gender, a user count, and a frequency of visit associated with the user (102). The one or more processors (202) may predict via the AI engine (210) one or more categorizations of the user (102) based on the generated one or more recognition metadata. The one or more categorizations of the user (102) may include, but not be limited to, a registered user, a repeat user, or a first time user.

In an embodiment, the ML engine (212) may utilize one or more data stored in the database (214) and compare it with the generated one or more recognition metadata of the user (102) to enable the one or more categorizations of the user (102).

In an embodiment, the one or more processors (202) may be configured to generate a blacklist for the user (102) based on the identification of the user (102). Further, the one or more processors (202) may be configured to generate an array of N dimensions based on the extracted one or more features and enable the generation of the blacklist.

In an embodiment, the one or more processors (202) may be configured to selectively process the received one or more images from the user (102) to generate the extracted one or more features.

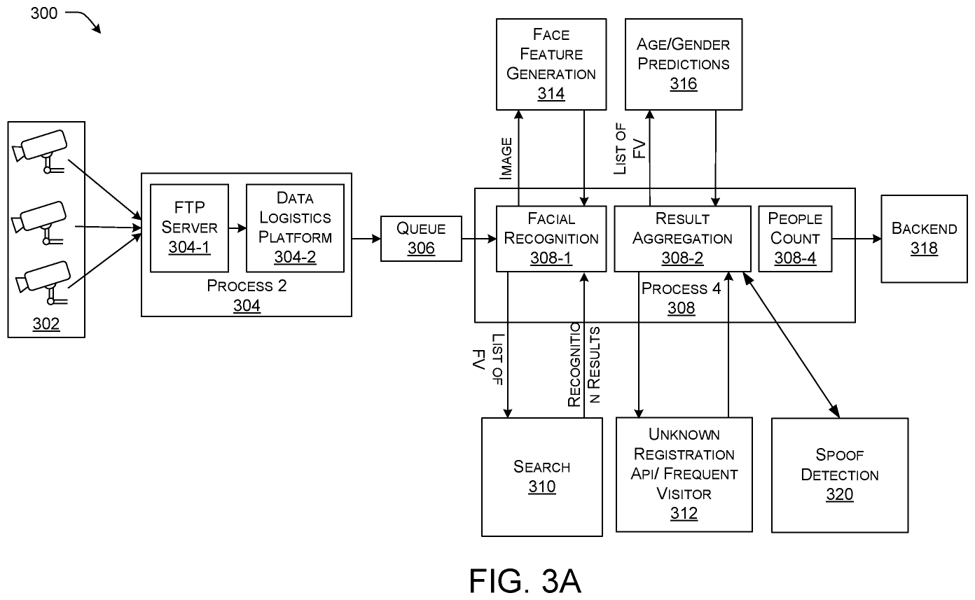

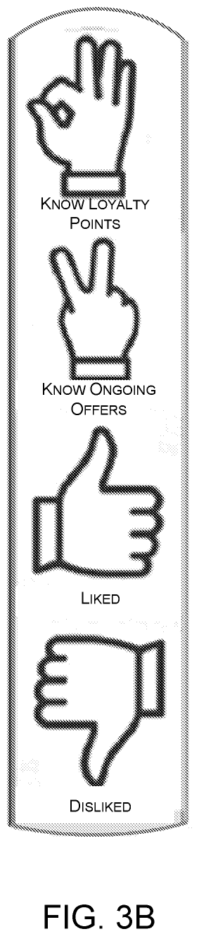

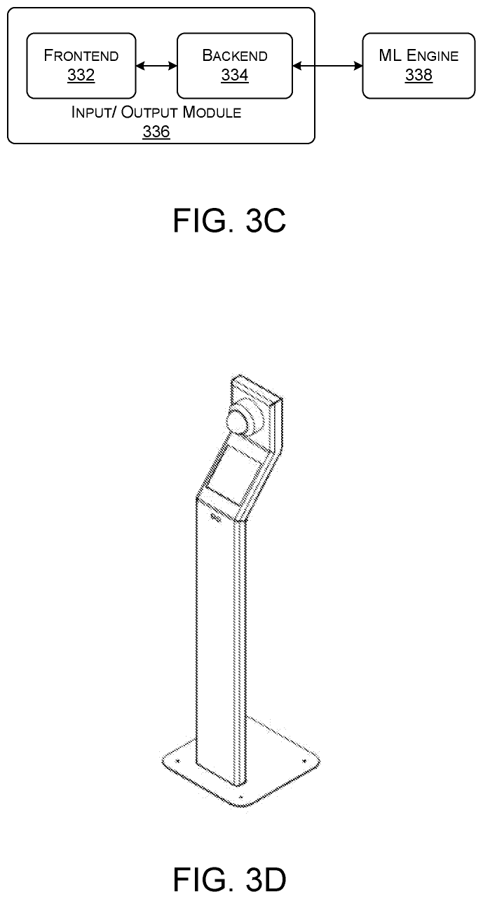

FIGS. 3A-3D illustrate exemplary block diagrams that represent a recognition pipeline of the system (110), in accordance with an embodiment of the present disclosure.

As illustrated, FIG. 3A shows a plurality of functional components associated with the basic flow description of the recognition pipeline. The first sub module may be a biometric capturing device such as a camera (302). The captured information may be sent to process 2 (304) comprising a file transfer protocol (FTP) server (304-1) and a data logistics platform (304-2). An edge device (i.e., camera) may upload images to a predefined location (i.e. the FTP server) as soon as a face is detected. These images may be then ingested by the data logistics platform (304-2) from the FTP server (304-1) to a messaging queue (306). The images may be further sent to process 3 (308) that may include a facial recognition module (308-1), a result aggregation module (308-2) and a people count module (308-3). The facial recognition module (308-1) may be operatively coupled to a face feature generation module (314) and a search module (310). A spoof detection module (320) may be operatively coupled to the result aggregation module (308-2) to identify the users (102) and blacklist unidentified users (102). The spoof detection module (320) may receive inputs from the facial recognition (308-1) module and provide the results to the result aggregation module (308-2). The search module (310) may be a database of facial features that may be used by the AI engine (210) (as illustrated earlier in FIG. 2) for generation of the one or more categorizations of the user (102). The result aggregation module (308-2) may be coupled to an age/gender prediction module (316) and a frequent visitor/unknown registration application programming interface (API) prediction module (312) to obtain a footfall count or a recognition result in conjunction with the results obtained from the result aggregation module (308-2).

In an embodiment, the system (110) may be utilized in a warehouse for security purposes. Further, the system (110) may utilize biometric authentication via captured facial images to recognize personnel across different locations. Further, the system (110) may provide various functionalities such an attendance capture, blacklist person alert, and people recognition.

In an embodiment, the system (110) may be installed in a warehouse for security purposes. The system (110) may be used for staff recognition, staff dress code verification, and recognition of blacklisted staff as a part of the security protocol.

In an embodiment, the system (110) may provide information to the management such as a staff to customer ratio to address various business needs from various customers.

In an embodiment, the system (110) may be utilized to identify age and gender of the person coming in front of the camera. The system (110) may provide age classification and particularly categorize children below 12 years age, teenager, adults between 22 to 35 years of age, and adults above 35 years of age.

In an embodiment, the system (110) may generate a footfall, i.e. record the numbers customers using the camera (302) as a part of entry flow management.

In an embodiment, the system (110) may generate customer analytics in the form of how frequently a particular customer visits the premises. This may further provide loyalty points to frequently visiting customers and increase business revenues.

As illustrated in FIG. 3B, the camera (302) may identify one or more gestures from a user (102). In an exemplary embodiment, the system (110) may recognize the gestures performed by the user (102) in the image, which in turn may be used to capture user (102) feedback and acknowledge it via an appropriate message on the dot matrix display in front of the user (102).

For example, the user (102) may request a query for knowing the number of loyalty points accumulated due to frequent visits to the warehouse using a particular gesture. Similarly, the user (102) may request information regarding ongoing offers using another gesture. Further, the user (102) may provide positive feedback or a negative feedback using another set of gestures as illustrated in FIG. 3B. An ordinary person skilled in the art may understand that the ML engine (338) shown in FIG. 3B may be similar to ML engine (212) of FIG. 2 in its functionality.

As illustrated in FIG. 3C, the input/output module (336) may include a frontend module (332) and a backend module (334) coupled to the ML engine (338). The frontend module (332) may include the following key functionalities
On boarding camera for access control and visitor analytics where camera details may be captured and sent to the backend module (334).
Displays recognized/unknown/backlisted persons with relevant metadata along with visitor analytics received from the backend module (334).

Further, the backend module (334) may receive the processed metadata from ML engine (338) and provide the processed metadata to the frontend module (332).

FIG. 3D illustrates an edge device equipped with a smart camera. The smart camera may upload frames to FTP server when it detects a face of the user (102). Further, the edge device may include a dot matrix display to acknowledge user's feedback and to show them appropriate message, hence acting as an interactive kiosk.

In an embodiment, the system (110) may include an edge device equipped with a smart camera (which may only upload frames to the (FTP) server when it detects a person's face) and a dot matrix display to acknowledge feedback from the user (102) and send appropriate messages to the user (102). Further, the edge device may acts as an interactive kiosk which may provide solutions to various queries requested by the user (102).

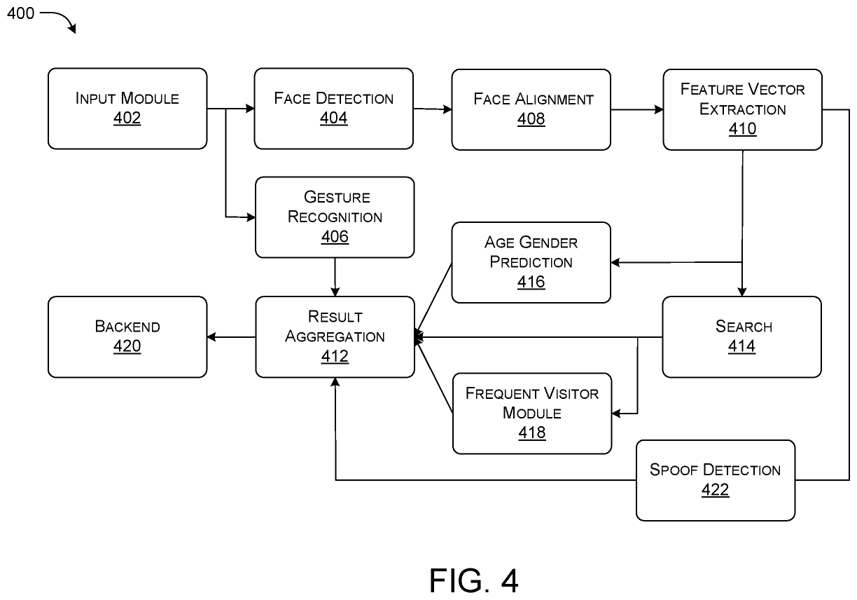

FIG. 4 illustrates an exemplary representation (400) associated with image capture and its implementation, in accordance with an embodiment of the present disclosure.

As illustrated, the block diagram (400) may include an input module (402). An edge device (i.e., camera) may upload images to a predefined location (i.e., FTP server) as soon as a user face is detected.

In an embodiment, the face detection module (404) may receive inputs from an input module (402). The inputs may include multiple facial images of a user (102). The face detection module (404) may detect all the facial images in a single frame and extract a bounding box, landmarks of the largest face (area wise) for further processing. The face detection module (404) may generate landmark points for eyes, nose and lips.

In an embodiment, the face alignment module (408) may receive the image and the face bounding box as input from the face detection module (404) and output an aligned face crop. Once face is detected i.e., its bounding box and landmarks are known, the image along with the facial landmarks may be passed as input to the face alignment module (408) which crops, resize and align the face so as to convert it to a standard shape and generate the aligned facial crop.

In an embodiment, a feature extraction module (410) may receive the aligned face crop as input and generate feature vectors as outputs using one or more face recognition models. The facial crop from the face alignment module (408) may be passed to recognition model for generation of the feature vectors. The recognition model may receive the aligned facial crop and extract features like nose, eyes, lips, etc. Using this feature, the feature extraction module (410) may generate a mathematical representation of the user face. The mathematical representation may be an array of N dimension which may then be stored in the database (214) (earlier illustrated in FIG. 2). Further, the feature extraction module (410) may send this information to a spoof detection module (422).

In an embodiment, the spoof detection module (422) may receive the generated feature vectors from the feature extraction module (410) and may predict via the ML engine (338) one or more categorizations of the user (102).

In an embodiment, a search module (414) such as but not limited to Milvus and MySQL may receive the feature vector as input from the feature extraction module (410) and generate one or more recognition metadata for identification of the user (102). The generated feature vector may be provided to Milvus for similarity search, where Milvus may calculate the distance of the N dimension array with vectors stored in the database (214) and return the best matching result. The best matching result may be then sent to the MySQL query for extraction of the relevant recognition metadata. The process may be repeated to generate a blacklist of the user (102) based on the identification of the user (102).

In an embodiment, an age and gender prediction module (416) may receive the feature vector from the feature extraction module (410) as input and classify user age and gender.

In an embodiment, a frequent visitor module (418) may receive the recognition metadata from the search module (414) and frame data from the age and gender prediction module (416) as inputs to generate determine whether the user (102) is a repeated visitor or a new visitor. The frequent visitor module (418) may analyse the user (102) image and the corresponding feature vector against a list of visitors registered in the database (214). The user (102) may be marked as a frequent visitor or classified as anew visitor for future reference.

In an embodiment, a gesture recognition module (406) may receive the frame data from the input module (402) as input and identify the gesture performed by the user (102) in the received image. The gesture recognition module (406) may detect and crop the hand region present in the image and further process the cropped image to highlight certain features. The highlighted features may be utilized by a classifier to identification of the gesture from the user (102).

In an embodiment, a result aggregation module (412) may receive the inputs from the gesture recognition module (406), the frequent visitor module (418), the spoof detection module (422), and the age and gender prediction module (416) as inputs and generate a footfall count and a recognition result. Further the user (102) may be categorized in three categories namely as a registered user, a first time user or a repeat user. The result from the result recognition module (412) may be clubbed with the results obtained from the gesture recognition module (406) and the age and gender prediction module (416) for further generating customer analytics. The result may be provided to a backend module (420) for further processing.

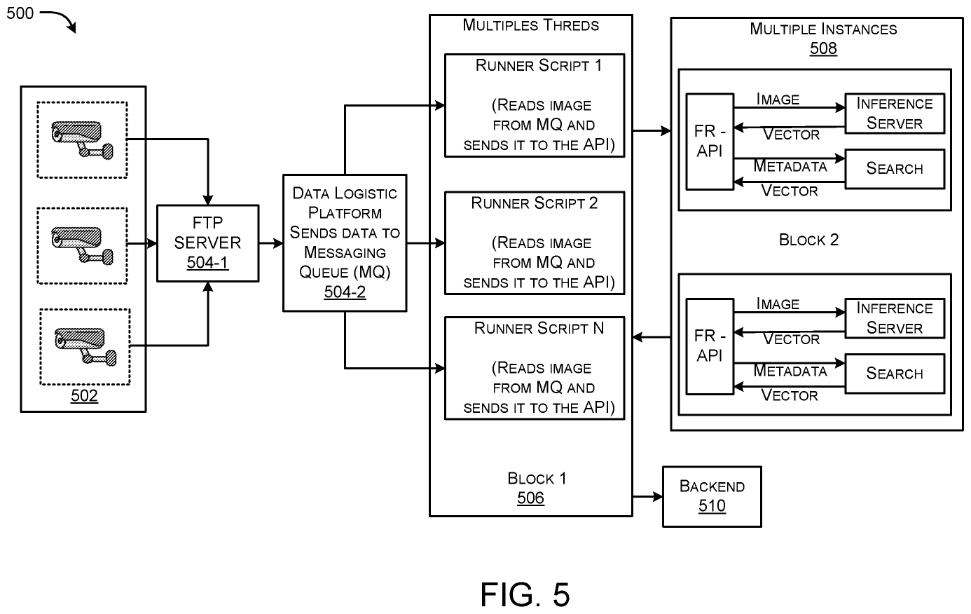

FIG. 5 illustrates an exemplary representation (500) associated with scaling of the proposed system (110) and its implementation, in accordance with an embodiment of the present disclosure.

As illustrated, the block diagram (500) may include a plurality of cameras (502), an FTP server (504-1), a data logistics platform (504-2), a plurality of threads for runner scripts (506), a backend module (510) and a multiple instances module (508) comprising a FR-API, an inference server, and a search module. As the plurality of cameras (502) are provisioned for the pipeline described in the block diagram (500), the plurality of cameras (502) may automatically start to upload useful frames to a unique directory in the FTP server (504-1). Further, the data logistic platform (504-2) may be appropriately configured to read data from newly added directories, thus simplifying and automating the camera on boarding procedure. Each module of the above pipeline may be served as a micro-service, which may be automatically scaled up or down depending upon the load on each module.

The data logistic platform (504-2) may send the data to a messaging queue, where plurality of threads for runner scripts (506) may read the data from the messaging queue and further send it to an API such as the multiple instances module (508). Additionally, the data logistic platform (504-2) may send the data to the backend module (510) for processing. The FR-API may be communicatively coupled with the inference server and the search module. The FR-API may send one or more images to the inference server and the search module for processing. The inference server and the search module may return recognition metadata to the FR-API for the one or more categorizations of the user (102).

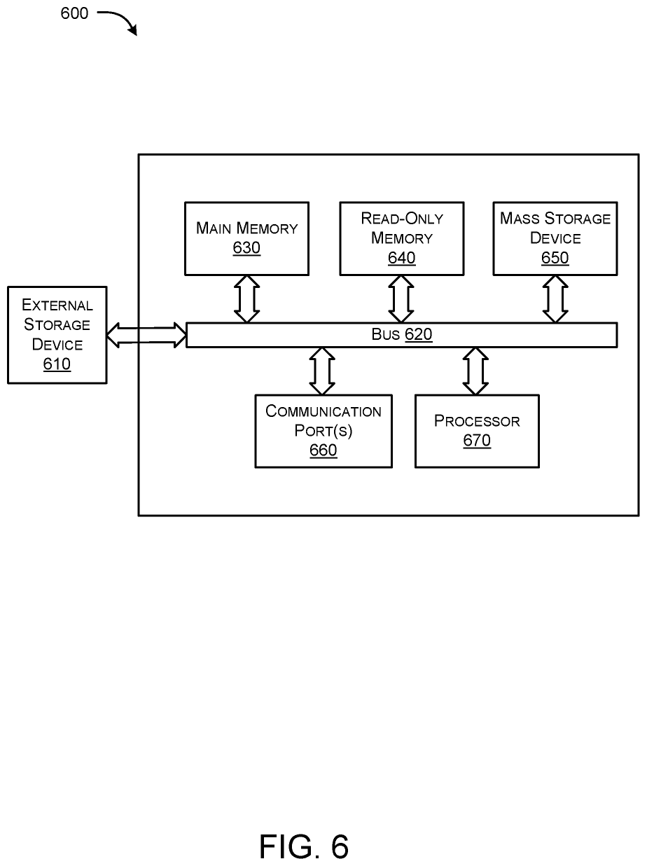

FIG. 6 illustrates an exemplary computer system (600) in which or with which the proposed system may be implemented, in accordance with an embodiment of the present disclosure.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method that uses a camera with in-built face detection which helps in reduction of continuous bandwidth towards a frame relay (FR) cloud.

The present disclosure provides a system and a method that uses an artificial intelligence (AI) based sensor light that helps in energy saving and makes the system functioning independent of external lightening.

The present disclosure provides a system and a method that utilizes biometric authentication using facial information to recognize personnel across different locations.

The present disclosure provides a system and a method that utilizes an FR-connect pipeline to provide an economically efficient solution, enable locations which were not having proper bandwidth, and support a large number of locations on the same hardware.

The present disclosure provides a system and a method that enables multiple functionalities catering to attendance capture, blacklist person alert, and visitor analytics.

I/We claim:

1. A system (110) for recognizing an entity, the system (110) comprising:
one or more processors (202) operatively coupled with a memory (204), and wherein said memory (204) stores instructions which when executed by the one or more processors (202) cause the one or more processors (202) to:
receive one or more images from a user (102), wherein the one or more images comprise one or more user faces, and wherein the user (102) operates through one or more computing devices (104) and is connected to the system (110) via a network (106);
extract one or more features associated with the one or more user faces to generate a feature vector based on the extracted one or more features;
generate one or more recognition metadata based on the generated feature vector to identify the user (102); and
predict, via an artificial intelligence (AI) (108) engine, one or more categorizations of the user (102) based on the generated one or more recognition metadata.

2. The system (110) as claimed in claim 1, wherein the generated one or more recognition metadata comprises at least one of: a user age, a user gender, a user count, and a frequency of visit associated with the user (102).

3. The system (110) as claimed in claim 1, wherein the one or more processors (202) are configured to perform spoof detection on the generated feature vector.

4. The system (110) as claimed in claim 1, wherein the one or more processors (202) are configured to compare the generated one or more recognition metadata with one or more data stored in a database and enable the one or more categorizations of the user (102) based on the comparison.

5. The system (110) as claimed in claim 1, wherein the one or more processors (202) are configured to generate a blacklist for the user (102) based on the identification of the user (102).

6. The system (110) as claimed in claim 5, wherein the one or more processors (202) are configured to generate an array of N dimensions based on the extracted one or more features and enable the generation of the blacklist based on the array.

7. The system (110) as claimed in claim 1, wherein the one or more categorizations of the user (102) comprise one of: a registered user, a repeat user, and a first time user.

8. The system (110) as claimed in claim 1, wherein the one or more features comprise at least one of: a bounding box, a landmark, and an aligned face crop associated with the one or more user faces.

9. The system (110) as claimed in claim 1, wherein the one or more processors (202) are configured to selectively process the received one or more images from the user (102) to extract the one or more features.

10. A method for recognizing an entity, the method comprising:
receiving, by one or more processors (202), one or more images from a user (102), wherein the one or more images comprise one or more user faces;
extracting, by the one or more processors (202), one or more features associated with the one or more user faces for generating a feature vector based on the extracted one or more features;
generating, by the one or more processors (202), one or more recognition metadata based on the generated feature vector to identify the user (102); and
predicting, by the one or more processors (202), via an artificial intelligence (AI) engine (108), one or more categorizations of the user (102) based on the generation of the one or more recognition metadata.

11. The method as claimed in claim 10, wherein the one or more recognition metadata comprises at least one of: a user age, a user gender, a user count, and a frequency of visit associated with the user (102).

12. The method as claimed in claim 10, comprising comparing, by the one or more processors (202), the generated one or more recognition metadata of the user (102) with one or more data stored in a database, and enabling, by the one or more processors (202), the one or more categorizations of the user (102) based on the comparison.

13. The method as claimed in claim 10, comprising generating, by the one or more processors (202), a blacklist for the user (102) based on the identification of the user (102).

14. The method as claimed in claim 10, comprising generating, by the one or more processors (202), an array of N dimensions based on the extracting of the one or more features, and generating, by the one or more processors (202), the blacklist based on the array.

15. The method as claimed in claim 10, wherein the one or more categorizations of the user (102) comprises one of: a registered user, a repeat user, and a first time user.

16. A user equipment (UE) (104) for recognizing an entity, the UE (104) comprising:
one or more processors communicatively coupled to one or more processors (202) in a system (110), wherein the one or more processors are coupled with a memory, and wherein said memory stores instructions which when executed by the one or more processors cause the one or more processors to:
transmit one or more images to the one or more processors (202) via a network (106),
wherein the one or more processors (202) are configured to:
receive the one or more images from the UE (104), wherein the one or more images comprise one or more user faces;
extract one or more features associated with a user (102) of the UE (104) to generate a feature vector based on the extracted one or more features;
generate one or more recognition metadata based on the generated feature vector to identify the user (102); and
predict, via an artificial intelligence (AI) engine (108), one or more categorizations of the user (102) based on the generated one or more recognition metadata.
